(19) United States
(12) Patent Application Publication
(10) Pub. No.: US 2025/0113408 A1
(43) Pub. Date: Apr. 3, 2025

(54) SMART WORKSTATION FOR MANUFACTURING OR REPAIRING A FUEL CELL

(71) Applicant: American Fuel Cell and Coated Fabrics Company, LLC, Magnolia, AR (US)

(72) Inventors: Adam Garfein, Ypsilanti, MI (US); Jeff Owens, Hope, AR (US); Travis Williams, Magnolia, AR (US); Faith Elliott, Camden, AR (US); Scott McMurty, Springhill, LA (US); Bryan Fields, Sevierville, TN (US); Michael Accordino, Manhattan Beach, CA (US)

(21) Appl. No.: 18/899,838

(22) Filed: Sep. 27, 2024

Related U.S. Application Data
(60) Provisional application No. 63/586,886, filed on Sep. 29, 2023.

(51) Int. Cl. H05B 1/02; G05D 23/19

(52) U.S. Cl. CPC H05B 1/023; G05D 23/19

(57) ABSTRACT

A smart workstation for manufacturing or repairing an article that requires heat to cure material is disclosed. The smart workstation comprises one or more distribution boxes. Each of the distribution boxes are connected to one or more cure heaters configured to cure an article at a configurable temperature for a configurable time duration. The smart workstation includes one or more programmable control systems configured to control the temperature of the time duration. Parameters of curing, including the temperature and the time duration, can be configured on a human machine interface (HMI) that is connected to the programmable control systems.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority of U.S. Provisional Application No. 63/586,886, filed Sep. 29, 2023, the entire contents of which are hereby incorporated by reference.

### BACKGROUND

This disclosure relates generally to a smart workstation, and more particularly to structure of a smart workstation and method of using the smart workstation to build or repair products.

### SUMMARY

Methods and apparatuses or devices disclosed herein each have several aspects, no single one of which is solely responsible for its desirable attributes. Without limiting the scope of this disclosure, for example, as expressed by the claims which follow, its more prominent features will now be discussed briefly. After considering this discussion, and particularly after reading the section entitled “Detailed Description” one will understand how the described features provide advantages.

In some embodiments, a smart workstation comprises a plurality of distribution boxes. Each of the distribution boxes are connected to a plurality of cure heaters configured to cure an article at a configurable temperature for a configurable time duration. The smart workstation includes one or more programmable control systems (e.g., programmable logic controllers (PLCs) or microcontrollers) configured to control the temperature of the time duration. Parameters of the smart workstation, including the temperature and the time duration, can be configured on a display screen of a human machine interface (HMI) that is connected to the programmable control system. The components of the smart workstation can be disposed on or about a work surface.

In one aspect described herein, a smart workstation for working on one or more articles, the workstation comprises a work surface; a plurality of heaters each movably disposed on the work surface and configured to apply heat to a corresponding portion of an article, each heater comprising a heater element and a temperature sensor; a programmable control system, the programmable control system configured to control each of the plurality heaters and receive temperature data from each of the plurality of heaters; and wherein the programmable control system is configured to control the heat applied by each of the of the plurality of cure heaters to maintain a temperature of the corresponding portions of the article within a desired temperature range.

In some embodiments, the smart workstation further comprises a human machine interface (HMI) in communication with the programmable control system, the HMI configured to receive the desired temperature range for each of the plurality of heaters.

In some embodiments, the smart workstation further comprising an alert circuit in communication with the programmable control system, and wherein the programmable control system is configured to provide an alert when the temperature of any of the corresponding portions of the article are outside of the desired temperature range.

In some embodiments, the alert circuit further comprises a visual indicator.

In some embodiments, the HMI is further configured to receive a time parameter for one or more of the plurality of heaters, and wherein the programmable control system is configured to maintain the temperature of the corresponding portions of the article within the desired temperature range for the received time parameter.

In some embodiments, the smart workstation further comprises at least one distribution box connected to the programmable control system and to one or more of the plurality of heaters, wherein the distribution box provides electrical power from the programmable control system to the one or more of the plurality of cure heaters and transfers data between the programmable control system and the one or more of the plurality of cure heaters.

In some embodiments, the smart workstation comprises a support frame coupled to the work surface, the support frame extending above the work surface and comprising a plurality of connection supports.

In some embodiments, each of the plurality of connection supports is configured to support the article.

In some embodiments, each of the plurality of connection supports is configured to support one of the plurality of heaters, and to maintain the heater in physical contact with the article.

In some embodiments, each of the plurality of heaters comprises an outer portion, and an inner portion, and wherein the outer portion is sized and shaped to fit a geometry of the surface of the article.

In some embodiments, the outer portion of the cure heater in contact with the surface of the article comprises a thermally conductive material.

In some embodiments, the plurality of articles are fuel cells.

In another aspect described herein, a method for working on one or more articles comprises: providing, on a work surface, an article to be worked; applying a plurality of heaters movably disposed on the work surface to corresponding portions of the article, each of the plurality of heaters comprising a heater element and a temperature sensor; applying, by each of the plurality of heaters, heat to the corresponding portions of the article; receiving, in a programmable control system, temperature data from each of the plurality of heaters; and maintaining a temperature of the corresponding portions of the article in a desired temperature range.

In some embodiments, applying the plurality of heaters to corresponding portions of the article comprises applying a first heater of the plurality of heaters to a first imperfection of the article and applying a second one of the plurality of heaters to a second imperfection of the article.

In some embodiments, a first heater of the plurality of heaters maintains the corresponding portion of the article in a first temperature range, and wherein a second heater of the plurality of heaters maintains the corresponding portion of the article in a second temperature range that is different from the first temperature range.

In some embodiments, the first heater is applied to a first imperfection of the article and wherein the second heater is applied to a second imperfection of the article.

In some embodiments, the method further comprises causing, in an alert circuit in communication with the programmable control system, an alert when the temperature of any of the corresponding portions of the article are outside of the desired temperature range.

In some embodiments, the method further comprises receiving, in a human machine interface (HMI) in communication with the programmable control system, a time parameter for one or more of the plurality of heaters; and maintaining the temperature of the corresponding portions of the article within the desired temperature range for the received time parameter.

In some embodiments, providing, on a work surface, an article to be worked comprises connecting the article to be worked to one or more of a plurality of connection supports coupled to a support frame, the support frame being coupled to the work surface.

In some embodiments, the method further comprises connecting one of the plurality of heaters to one of the plurality connection supports; and placing the one of the plurality of heaters connected to the one of the plurality of connection supports in contact with the article.

In another aspect described herein, a system for curing an article comprises a control panel; a user interface in communication with the control panel, the user interface configured to receive curing parameters for an article to be worked; a plurality of cure heaters, each movably disposed on a work surface, each cure heater comprising at an outer portion forming an internal enclosure, a heater element and a temperature sensor disposed within the internal disclosure, the heater element connected to a power supply of the control panel, the temperature sensor connected to a signal line of the control panel; and wherein each of the plurality of cure heaters is configured to heat up a corresponding article as controlled by the control panel, thereby increasing a temperature of the article to an elevated temperature for a time duration, and wherein the control panel is capable of determining if the elevated temperature is out-of-tolerance from a signal retrieved on the signal line from the cure heater.

In some embodiments, when the out-of-tolerance is determined the control panel brings the elevated temperature within a temperature tolerance range by controlling electrical power delivered to the cure heater.

In some embodiments, the temperature tolerance range is defined by an upper temperature limit and a lower temperature limit.

In some embodiments, when the out-of-tolerance is determined the control panel emits an alert by a notification light coupled to the work surface and/or a software notification displayed on the HMI.

In some embodiments, when operating on one of the numerous articles, the corresponding cure heater is pressed on a surface of the article by a clamp.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is a perspective view of an embodiment of a smart table or workstation.

FIG. 2 is a side view of the smart workstation of FIG. 1.

FIG. 3 is a perspective view of an embodiment of a smart workstation.

FIG. 4 is a perspective view of a distribution box shown in FIG. 1 or 3.

FIG. 5 is a perspective view showing more than one distribution boxes disposed on a work surface, with each of the distribution boxes connected to a plurality of cure heaters.

FIG. 6 is a perspective view showing a cure heater and a connection cable shown in FIG. 5.

FIG. 7 is a perspective view showing a cure heater placed and clamped on a surface of a fuel cell bladder.

FIG. 8 is a perspective view showing different types of connection plugs coupled to a connection cable.

FIG. 9 is a perspective view illustrating the plugs shown in FIG. 8 plugged in the distribution box shown in FIG. 4.

FIG. 10 is a perspective view showing a human machine interface (HMI) attached to a control panel.

FIG. 11 is a view of the HMI of FIG. 10 displaying certain interactive features and data.

FIG. 12 is a view of an interactive screen on the HMI of FIG. 10 for inputting Operator ID.

FIG. 13 is a view of the HMI of FIG. 10 displaying product information.

FIG. 14 is a view of an interactive screen on the HMI of FIG. 10 for setting a process parameter.

FIG. 15 is a perspective view showing a notification light attached on a post.

FIG. 16 is a view of the HMI of FIG. 10 displaying a software notification.

FIG. 17 is a view of an interactive screen on the HMI of FIG. 10 for setting security log in.

FIG. 18 is a view of the HMI of FIG. 10 displaying records of performance for the smart workstation shown in FIGS. 1 to 3.

### DETAILED DESCRIPTION

Methods and apparatuses or devices disclosed herein each have several aspects, no single one of which is solely responsible for its desirable attributes. Without limiting the scope of this disclosure, for example, as expressed by the claims which follow, its more prominent features will now be discussed.

In the following detailed description, reference is made to the accompanying drawings, which form a part thereof. In the drawings, similar symbols typically identify similar components, unless context dictates otherwise. Thus, in some embodiments, part numbers may be used for similar components in multiple figures, or part numbers may vary from figure to figure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Fuel cells or “bladders” can be difficult to manufacture or repair. The systems and methods described herein relate to manufacture and/or repair of fuel cells or “bladders,” for example, aviation fuel cells which are high quality, ballistic fuel cells. Although the current description describes fuel cells, the concepts described herein can be used to manufacture or repair any type of article including rubber or fabric bladder, or other material that can be cured by heat (or vulcanized). Cells or bladders described herein can also be used for any type of fluid such as water, syrup or oil, in addition to fuel. The present disclosure describes a smart table or a smart workstation. These terms can be used interchangeably.

When a large fuel cell or bladder is manufactured, due to manufacturing limitations, there may be imperfections, flaw, tears, weak spots, etc., in the fuel cell. These imperfections are small or localized, so treating a large portion or the entire bladder could change the characteristics of the bladder. To correct these imperfections or flaws, localized treatments can be applied to the imperfections or flaws. Some treatments can include providing a specific temperature program having a temperature profile to the imperfection, such as heating and/or maintaining a specific temperature or temperature range for a given period of time. The temperature program can cure the rubber in a specific way to address the imperfection or flaw. In some cases, there may be several imperfections that need to be addressed. The systems and methods described herein provide for addressing these manufacturing issues and provide an autonomous or semi-autonomous system for applying treatments to one or more imperfections at the same time. These systems provide increased accuracy of temperature treatments, reduce the requirement for operator involvement, and improve efficiency by treating multiple imperfections simultaneously. When the temperature of the bladder or fuel cell being worked reaches a desired point or range, or when the temperature has been maintained at the desired level for the desired time, the systems can automatically turn off or secure the heaters, ensuring that the cure is done properly. Where more than one location is being heated or cured, the systems and methods here can operate separately or independently, automatically monitoring and turning off heaters at different points of the fuel cell or bladder as the temperature set points or time set points are reached.

As described herein, a smart table is comprised of multiple physical components and software running on one or more control systems, e.g., processors. The smart table provides for a controlled application of heat in a specified or desired profile or protocol on a specific area of the cell or bladder in order to cure the bladder material.

The term “smart table” or “workstation” can refer to a platform solution that enables targeted, specific, and efficient curing of a product using digitally controllable heaters. In some embodiments, the smart table or workstation can comprise a work surface, such as a tabletop, benchtop or table stand. Other configurations are possible and can be placed on the floor or any physical arrangement to hold the work product(s) in place, based on the size, shape, and/or type of the work product, e.g., the cell or bladder.

A smart table may provide one or more stations, each of which can be configured to be operated by a human operator to cure work products, such as fuel cells or bladders. Each station may be provided with one or more heating devices, each of which is capable of curing a fuel cell or bladder as controlled by the control systems according to specified or desired profile or protocol programmed in the control system.

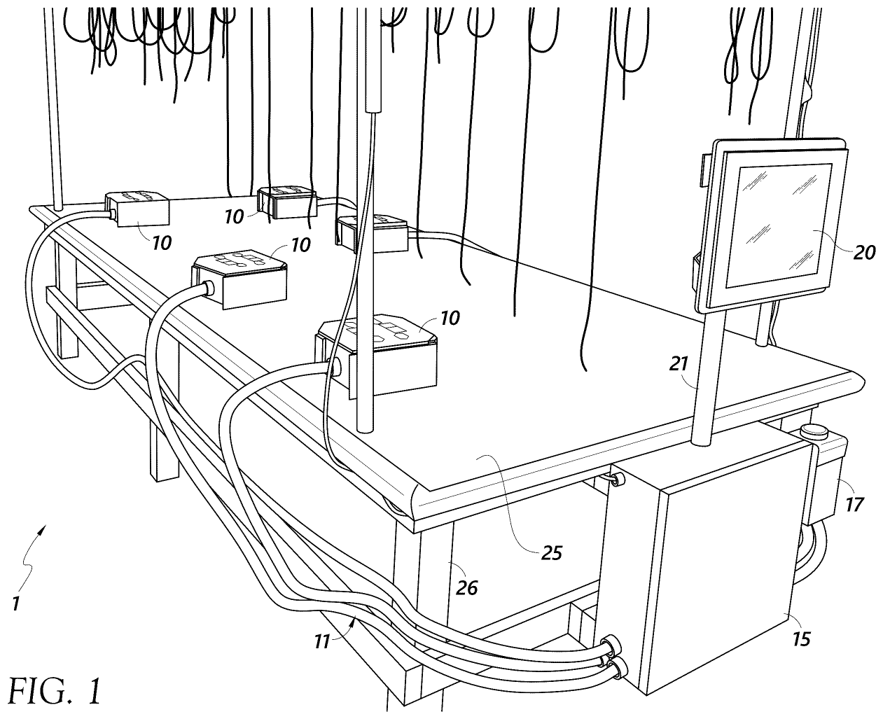

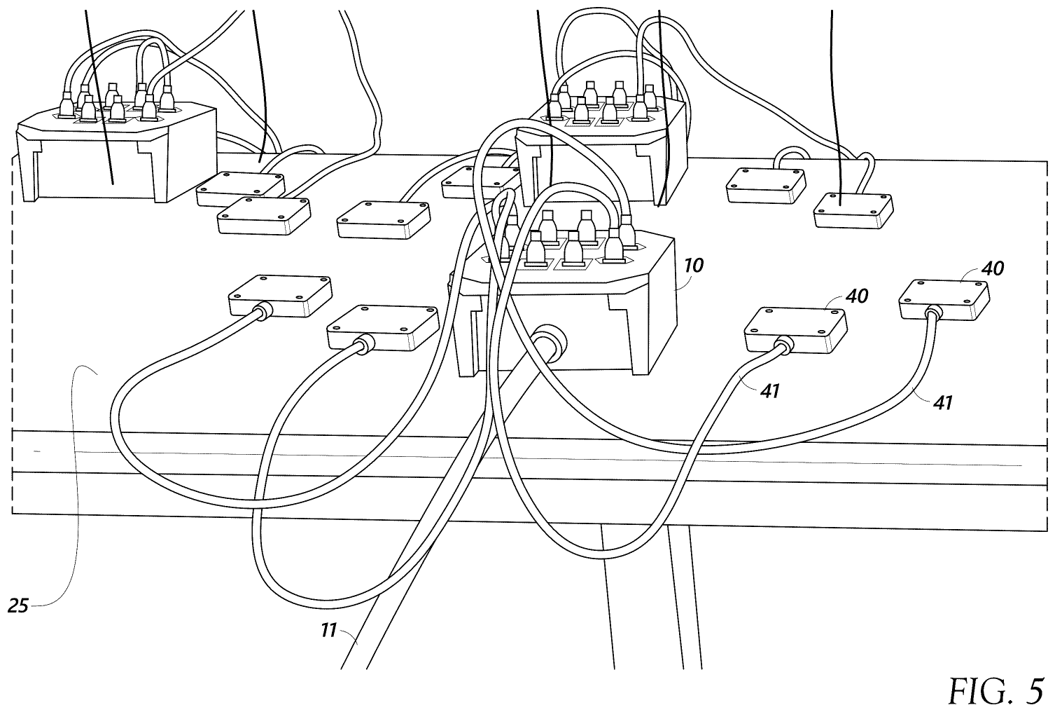

FIG. 1 shows an example embodiment of a smart workstation 1 for building or repairing articles or products, e.g., fuel cells or bladders. The smart workstation 1 comprises a plurality of distribution boxes 10 disposed on a substantially flat work surface or benchtop 25. Each of the plurality of distribution boxes 10 is connected to a central control panel 15 at an end of the benchtop 25 through a respective distribution cable 11. In FIG. 1, the central control panel 15 has a box shape configured to include therein one or more programmable control systems that can independently control a plurality of devices of the smart workstation 1, and/or processes the smart workstation 1 is configured to perform. In some embodiments, one programmable control system is configured to control a plurality of devices. The control system is configured to apply temperature programs to different parts of the item being worked, to monitor temperatures and elapsed times, and to automatically turn off heaters when the program has completed or when the desired temperature has been reached. In some embodiments, more than one programmable control system is included in the control panel 15 to control a plurality of devices. Examples of such programmable control systems may include programmable logic controllers (PLC), microcontrollers or processors, and may include one or more data storage devices, e.g., non-transitory computer-readable mediums, to store system configuration data and product data. A human machine interface (HMI) 20 is connected to the control panel 15 via an adjustable support 21 that may include an electrical cable therein to electrically connect the HMI 20 and the control panel 15. The electrical cable may include a power cord and a data cord. In other embodiments, the HMI 20 may be connected to the control panel 15 wirelessly for data transfer. Although the HMI 20 is shown in FIG. 1 disposed vertically above the control panel 15, the HMI 20 can be disposed at a different location, e.g., remotely from the control panel 15 or the smart workstation 1. The smart workstation 1 is shown configured with five distribution boxes 10, but the number of connected distribution boxes 10 can be more or less than five depending on the capacity needed and the size of the benchtop 25, among other factors. As will be described below, each distribution box 10 can support one or more cure heaters (FIG. 5). The distribution cable 11 connected to each distribution box 10 is flexible at least for a portion of the cable that is next to the distribution box 10. As such, an operator can move the distribution boxes 10 to different locations on the benchtop 25 as required and place them close to the product (e.g., fuel cell) being built or repaired, or near the locations on the cell or bladder needing curing, repair, or maintenance. The benchtop 25 rests on one or more stands 26 which may be set to a proper height, including directly on a floor. A breaker box 17 connects the control panel 15 to an external power and may also hold a network connector therein.

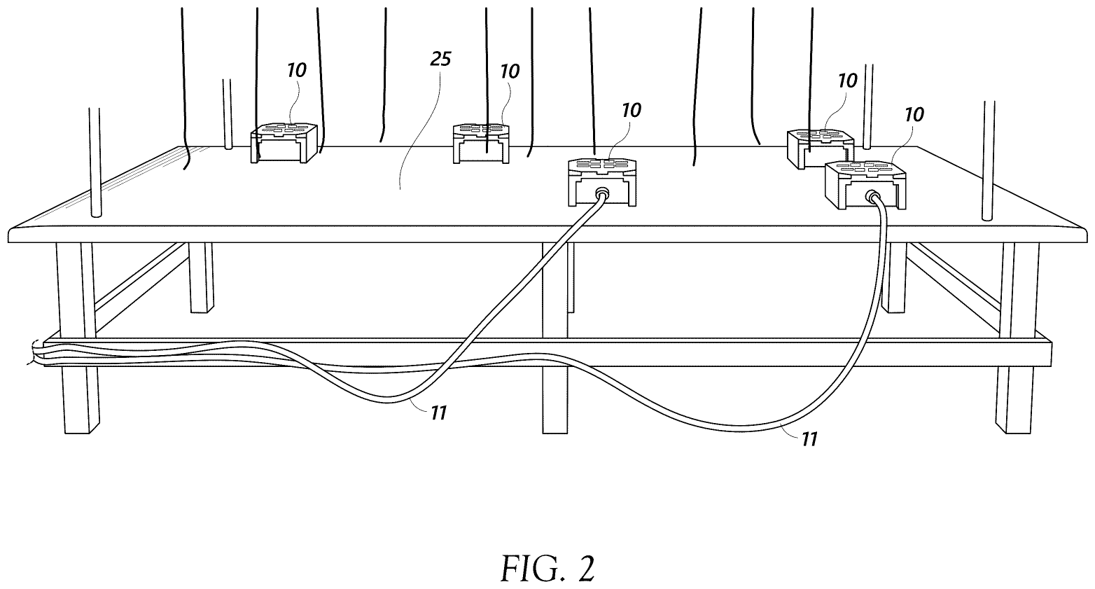

Referring to FIG. 2, a side view of the smart workstation 1 of FIG. 1 is shown. As can be seen, the distribution boxes 10 rest on the benchtop 25. Two distribution cables 11 are shown connected to respective distribution boxes 10.

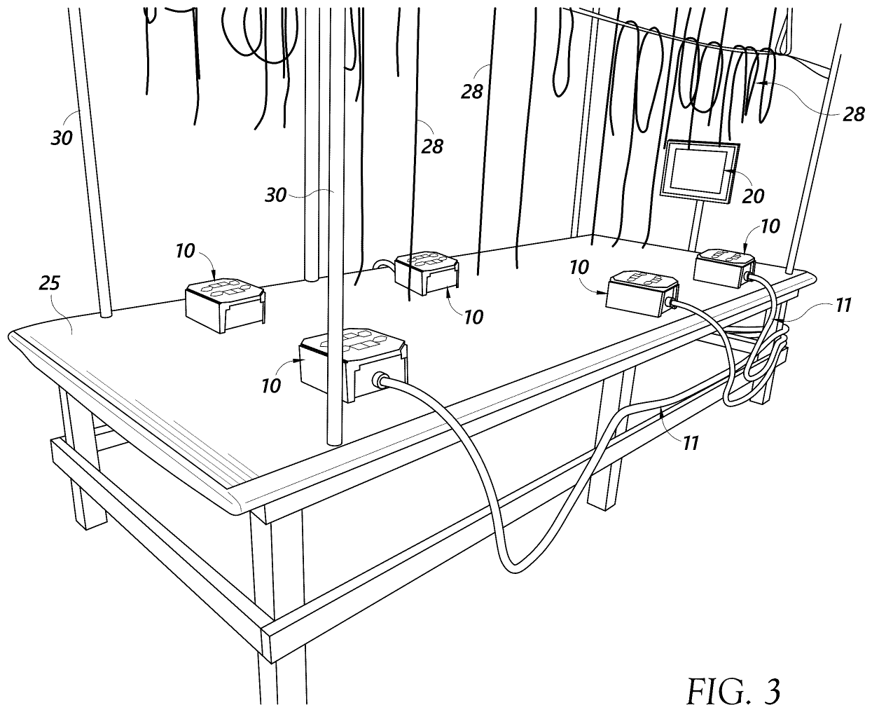

FIG. 3 shows a perspective view of an embodiment of a smart workstation 2. Similar to the smart workstation 1 shown in FIG. 1, the distribution boxes 10, the distribution cables 11, and the HMIs 20 are disposed on or about the benchtop 25. Instead of one HMI 20 connected to the smart workstation 1 in FIG. 1, the smart workstation 2 has 2 HMIs 20 connected therewith.

Some fuel bladders are typically very flexible and require a support mechanism to maintain their defined shape when placed on the work surface such as the benchtop 25. A fuel bladder can be supported from within, such as with supporting posts, frame or other applicable structures using appropriate materials to support the fuel cell without damaging it (not shown). Alternatively, or in conjunction with internal supports, external supports can be used to help the fuel bladder to maintain its defined shape. An external support frame 30 having vertical bars and horizontal members is shown coupled to the benchtop 25. A plurality of connection strings, wires, or connection supports 28 are attached to the horizontal members of the support frame 30 and extend downward. The connection supports 28 are configured to be tied to and hold the product in place during a manufacturing or rework operation. An operator can also suspend one or more of the distribution boxes 10 above the benchtop 25 using the connection supports 28 and/or the support frame 30 for optimal placement or ergonomics of the distribution boxes 10. Positioning the distribution boxes 10 in configurable orientations and horizontal/vertical locations can benefit the manufacturing or repairing operation and promote quality and efficiency.

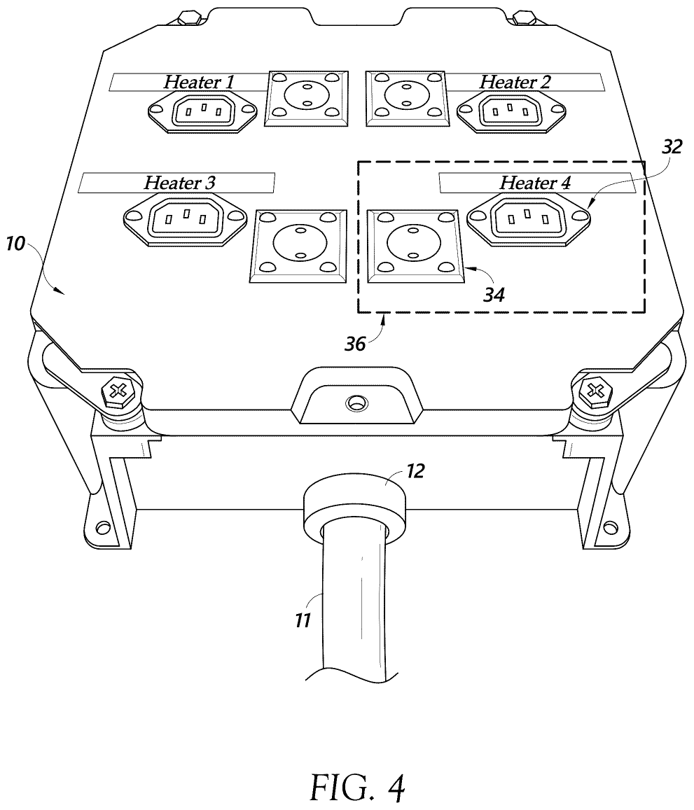

FIG. 4 shows a perspective view of an embodiment of the distribution box 10 and a connector 12 forming a terminal end of the distribution cable 11. The connector 12 is configured to connect the distribution cable 11 to the respective distribution box 10. The distribution box 10 has one or more electrical sockets 32 configured to provide programmable electrical power to a plurality of cure heaters (as shown in FIG. 5). The distribution box 10 may have one or more data sockets 34 configured for monitoring or sending data for the control of the manufacturing or repairing operation. As shown in FIG. 4, an electrical socket 32 is paired with a data socket 34 to form a socket pair 36.

FIG. 5 depicts three distribution boxes 10 disposed on the benchtop 25. Each of the three distribution boxes 10 is connected to a plurality of cure heaters 40. The plurality of heaters 40 are disposed on the benchtop 25 around their respectively connected distribution box 10. The connection of each of the plurality of cure heaters 40 to the respective distribution box 10 is via a connection cable 41. As indicated above, each connection cable 41 is configured to connect to one of the socket pairs 36 formed in the distribution box 10. Although 4 socket pairs 36 are shown in a single distribution box 10 (FIG. 4) and 4 cure heaters are depicted connected to the distribution box 10, this is exemplary only. In some embodiments, each distribution box 10 may have more or fewer than 4 socket pairs. In some embodiments, each distribution box 10 may have a different number of socket pairs 36, as needed for the fuel cells and/or the operations to be undertaken on the smart workstation. Although not shown in FIG. 5, the fuel cell or bladder being worked, cured, heated, etc., can be placed on the benchtop 25, can be suspended from the supports, or can have a portion on the benchtop 25 and a portion suspended via the supports 28, and the heaters 40 and other components can be applied to the fuel cell or bladder being worked.

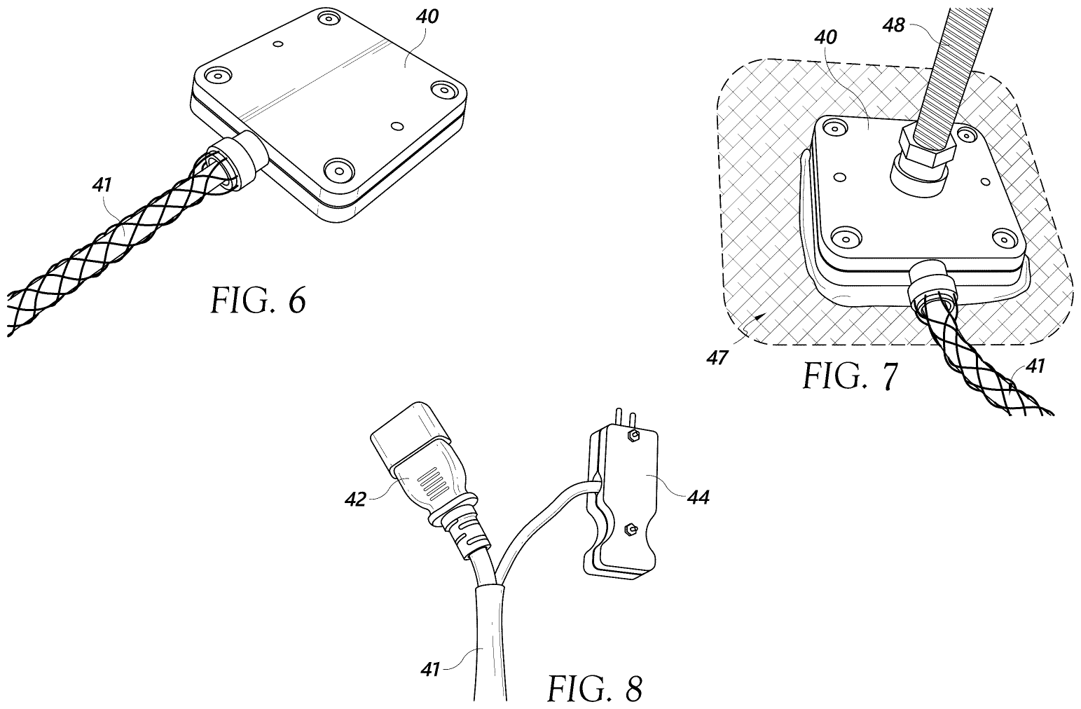

FIG. 6 shows a perspective view of the cure heater 40 described above and the connection cable 41 configured to connect the cure heater 40 to one of the distribution boxes 10 on the benchtop 25. The connection cable 41 may encase therein an electrical power cord and a data cord, e.g., temperature sensor or thermocouple connection wires. The cure heater 40 can be made in any suitable shape and with any suitable material. As shown in FIG. 6, the cure heater 40 is a short square or rectangular prism comprising at least two outer portions, e.g., an upper outer portion and a lower outer portion stacked together, forming an internal enclosure or inner portion, and may have one or more electrically powered heater elements and one or more temperature or thermocouple sensors residing therein. At least one of the upper and the lower outer portions of the cure heater 40 may comprise a metallic material, e.g., aluminum, copper, or iron (e.g., steel), for high thermal conductivity. Each cable included in the smart workstation 1 or 2, including the connection cable 41 and the distribution cable 11, may include a protective sheathing to reduce wear and prevent damage. Each of the one or more heater elements in a cure heater 40 can be controlled individually or as part of a group according to the desired program and the manufacturing or maintenance needs. In some embodiments, the connection cable 41 can provide signals to each of the cure heaters 40. In some embodiments, each of the cure heaters 40 can have one or more processors therein to control and operate the temperature sensor or thermocouple and each of the one or more heater elements. The connection cable 41 also provides information, for example, heater operation, heater location, thermocouple readings, etc. for each of the plurality of cure heaters 40 to the control panel 15, and the status, readings, and information from each of the plurality of cure heaters 40 can be depicted on and operated from the HMI 20.

Referring to FIG. 7, the cure heater 40 connected to the connection cable 41 is shown placed on a surface 47 of an article or product being worked or built. The article may be a fuel cell or bladder. The cure heater 40 is held in place by an adjustable clamp 48 placed against an upper surface of the cure heater 40. The clamp 48 can be any type of clamping mechanism capable of holding the cure heater 40 firmly in place on the article surface 47 during a cure cycle of the operation. The cure heater 40 can be custom designed to fit the geometry of article surface 47 as such allowing a large contact area between the cure heater 40 and the article surface 47, and in turn the clamp 48 can be customized to fit the geometry of the upper surface of the cure heater 40 accordingly to cause full or flush contact between the cure heater 40 and the article surface 47. The outer portion of the cure heater 40 that is in contact with the article may comprise a metallic material as described above. The large contact area between the cure heater 40 and the article surface 47 and the high thermal conductively of the outer portion of the cure heater 40 allow high conduction heat transfer to occur from the cure heater 40 to the article being produced or repaired. This high conduction heat transfer in turn causes a rapid temperature rise of the article being produced or prepared when the heater element(s) residing in the cure heater 40 is turned on.

FIG. 8 depicts the connection cable 41 coupled to an electrical power plug 42 and a data plug 44. The electrical power plug 42 is configured to be plugged into one of the electrical sockets 32 shown in FIG. 4. Likewise, the data plug 44 is configured to be plugged into one of the data sockets 34 shown in FIG. 4.

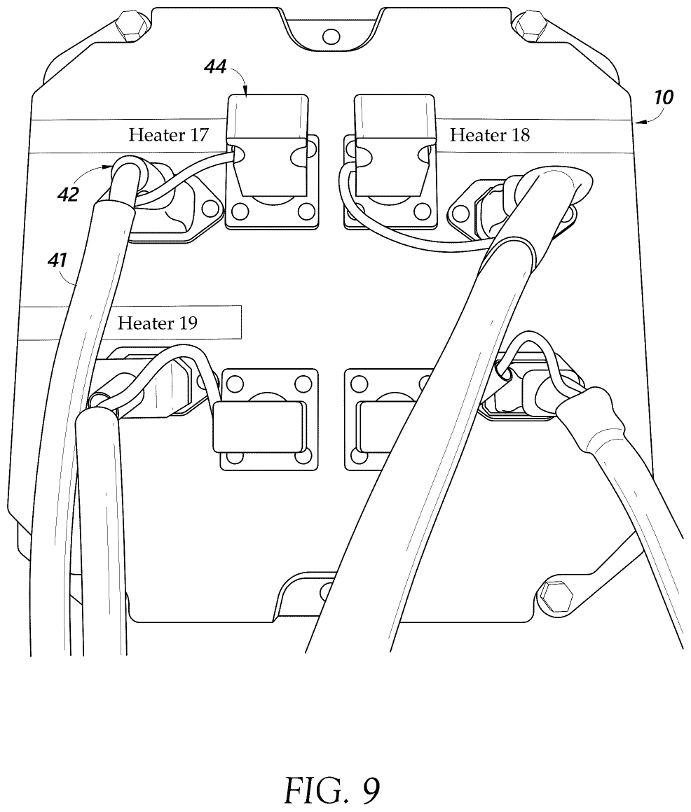

As shown in FIG. 9, the electrical plug 42 and data plug 44 of each connection cable 41 are plugged into the electrical socket 32 and the data socket 34 of one of the socket pairs 36 shown in FIG. 4.

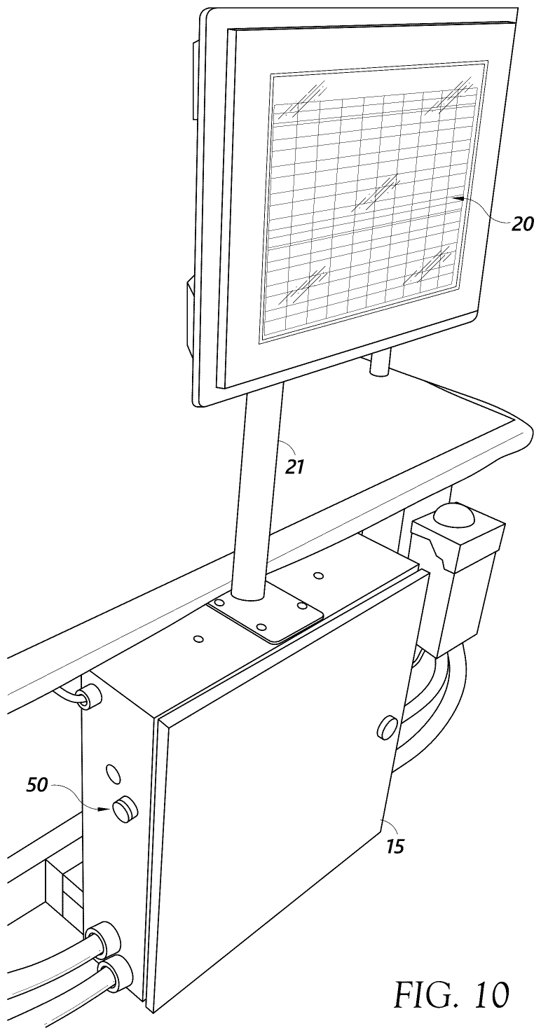

FIG. 10 depicts the HMI 20 disposed above the control panel 15, providing an interface, capable of presenting data to and receiving instructions from the operator (e.g., a human operator). In some embodiments, the programmable control systems (e.g., processors) residing in the control panel 15 can be configured to receive and execute instructions and programs provided to the HMI 20 from the operator. A notification light 50 may be implemented on a surface of the control panel 15, configured to signal an event, e.g., when a process experiences an out-of-control situation. The notification light 50 may blink or emit continuous light, configured to show different situations. The notification light 50 may have different colors to indicate different processes or event severities. The condition causing the notification light 50 to luminate can also be indicated on the HMI 20. In some embodiments, the control system can comprise a plurality of notification lights. In some embodiments, the HMI 20 can include notification lights 50, emit notification sounds from an enunciator (not shown), and the like. In some embodiments, the condition is an error or malfunction, such as a temperature deviation in a cure heater from a temperature specification range, or failure of a component. In some embodiments, the condition is a completion of a cycle or segment of a cycle. In some embodiments, the condition can be the attaining of a specified temperature or other condition. In some embodiments, the application of heat via a cure heater 40 may be accomplished in one or more segments or stages with different heat applications or timing. These segments or parameters can be inputted at the HMI 20 or via a remote device in communication with the HMI 20.

In some embodiments, the HMI 20 has wired or wireless communication with one or more computing devices, such as servers, mobile computing devices, etc. Any condition or operation of the smart workstation can be reported or controlled remotely via a device in communication with the HMI 20.

As shown above, the one or more programmable control systems (e.g., PLCs, microcontrollers, or processors) are residing in the control panel 15 configured to control the different devices in the smart workstation. These controls can be input via the HMI 20. In the smart workstations described herein, the programmable control systems may be programmed and configured to control each of the plurality of cure heaters 40 independently according to process parameters configured on the HMI 20. The heater or heating element residing in each of the cure heaters 40 may be controlled by the connected programmable control system to turn on and off, at a set level, etc., to heat up the cure heater 40. The thermocouple sensor residing in the cure heater 40 may sense the temperature of the cure heater 40 and/or the portion of the fuel cell or bladder being heated, and transfer the temperature data back to the programmable control system. The control signals and the measurement data transfer can occur through the distribution cable 11 from the control panel 15 to the distribution box 10, and the connection cable 41 from the distribution box 10 to the cure heater 40. The processes the cure heaters 40 are configured to carry out may be programmed and configured on the HMI 20. Although the devices disclosed herein the control panel 15 is configured to control are the cure heaters 40, other proper devices can be controlled within the scope of the present disclosure. For example, the devices can be a plurality of soldering guns, a plurality of testing devices for testing microelectronics or printed circuit boards (PCBs), or other suitable devices.

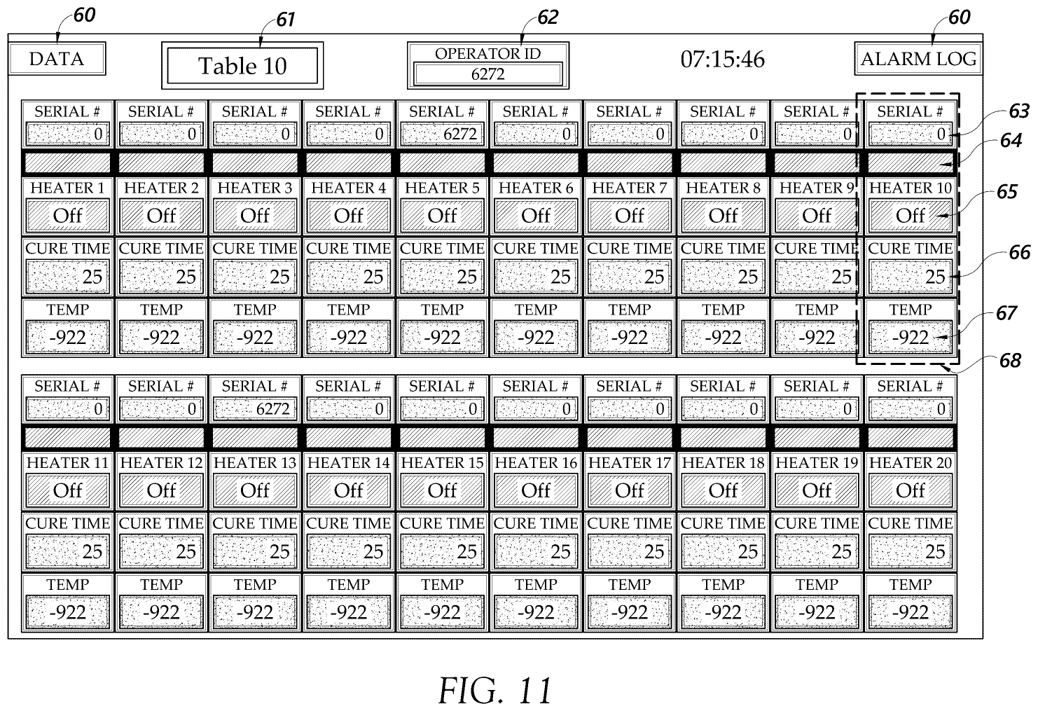

As shown in FIG. 11, the HMI 20 may include an interactive touch screen. The HMI 20 may be capable of displaying customizable buttons and contents on the screen. For example, the display screen of the HMI 20 shown in FIG. 11 includes two navigation buttons 60, one at each top corners of the screen, with an identifier button 61 for each smart workstation (e.g., smart workstation 1), and a human operator identifier button 62, both along the top central region of the screen. The HMI 20 is in commuicatin with the programmable control system, and is configured to receive a plurality of parameters for the article or item being worked, such as a temperature parameter, a temperature range, and a time parameter. In some embodiments, the plurality of parameters can be a control program, which includes one or more temperature ranges and associated time periods, for example, maintain a first temperature range for a first time period, and then maintain a second temperature range for a second time period, followed by a cool down of a third time period. The HMI 20 is configured to display a plurality of subsections 68 on the display screen, each displaying information reflecting configuration and performance status of an associated individual cure heater 40. Specifically, each display subsection 68 may include a product identifier 63, a cure status indicator 64, an on/off status 65 of the associated cure heater 40, a cure time 66, and a cure temperature 67 for the respective cure heater 40, retrieved from the non-transitory computer-readable medium as part of the programmable control system. The requirements or tolerance specification for the cure time 66 and the cure temperature 67 for the respective cure heater 40 may vary from product to product and may be configured through the HMI 20.

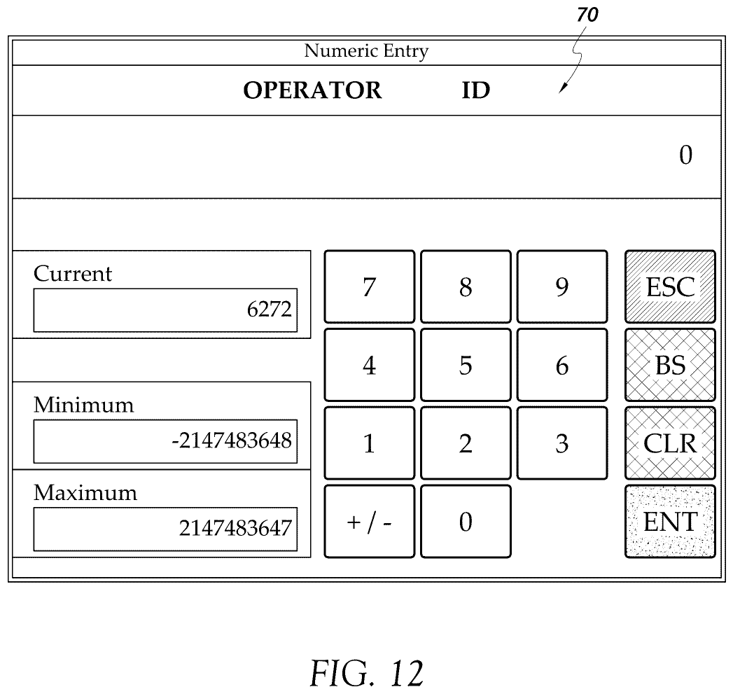

FIG. 12 shows an operator identification form 70 available on the HMI 20 where the human operator can enter or select his/her employee identification. For example, the human operator may access and display the operator identification form 70 by pushing the operator identifier button 62 shown in FIG. 11.

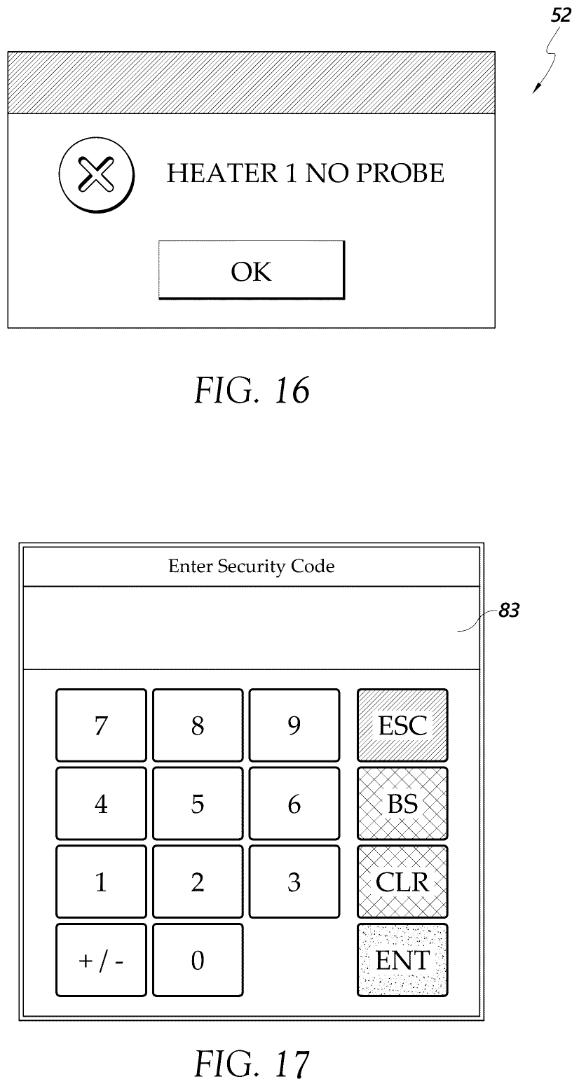

In some embodiments, the display of the interactive HMI 20 may include upper temperature limits and lower temperature limits of the cure heaters 40 according to the process control limits of a specific product being manufactured or repaired. The upper temperature limit and lower temperature limit set limits or a tolerance range for the notification light 50 to signal an alarm and possibly an additional software notification 52 (FIG. 16) on the HMI 20 to display an alarm once the sensed temperature of the respective cure heater 40 is outside of the temperature limits or the tolerance range. The programmable control system connected to the cure heater 40 is configured to adjust the heating of the cure heater 40 to bring temperature of the cure heater 40 to within the temperature range or tolerance range defined by the upper temperature limit and lower temperature limit.

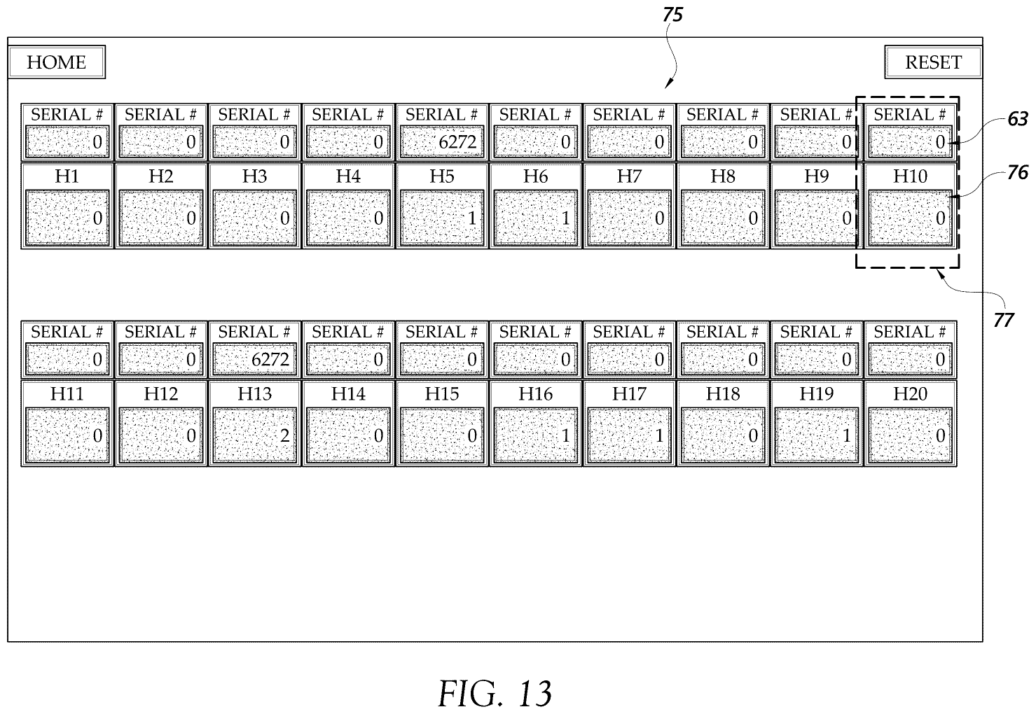

In FIG. 13, a product and cure heater configuration form 75 is displayed on the screen of the HMI 20. The configuration form 75 may include the product identifier 63 and a cure heater identifier 76. For example, each of the cure heaters 40 can be assigned a unique identifier and can be input into the control panel 15 through the HMI 20. When the operational data of the cure heaters 40 are tracked and stored, it offers traceability, so that product quality issues can be identified with each the cure heaters 40. On the screen of the HMI 20, an operation subsection 77, including a product identifier 63 and a cure heater identifier 76, is associated with products built with the specific cure heater 40.

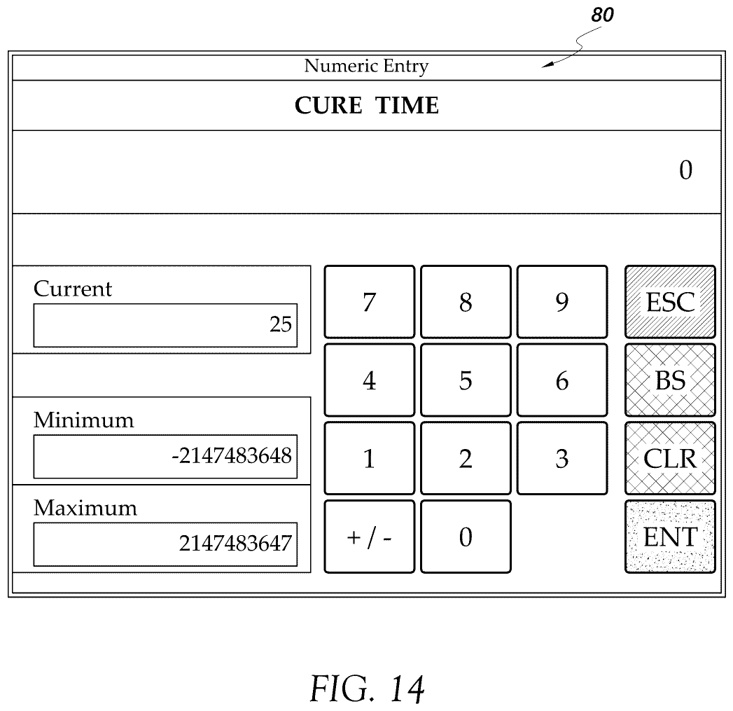

As shown in FIG. 14, an authorized human operator can configure a cure time duration control limit form 80 available on the HMI 20, including setting a cure time duration for each of the cure heaters 40. As with respect to FIG. 12, in some embodiments, the interactive HMI 20 may include upper temperature limit and lower temperature limit of an associated cure heater 40 according to the process limits of a specific product being built. These upper temperature limit and lower temperature limit set limits for the notification light 50 to signal alert and possibly an additional software notification 52 on the screen display the alert. The associated programmable control systems residing in the control panel 15 are configured to enforce the upper temperature limit and lower temperature limit, or tolerance range, and cure time duration. This means that if the temperature of a cure heater 40 is sensed below the lower temperature limit, the programmable control system will increase the electrical power delivered to the cure heater 40 so that the temperature of the cure heater 40 will be increased to above the lower temperature limit. On the other hand, if the temperature of a cure heater 40 is sensed above the upper temperature limit, the programmable control system will decrease the electrical power delivered to the cure heater 40 so that the temperature of the cure heater 40 will be decreased to below the upper temperature limit. The programmable control systems may continuously control the electrical power delivered to each of the plurality of cure heaters 40 according to the sensed temperatures from the cure heaters 40.

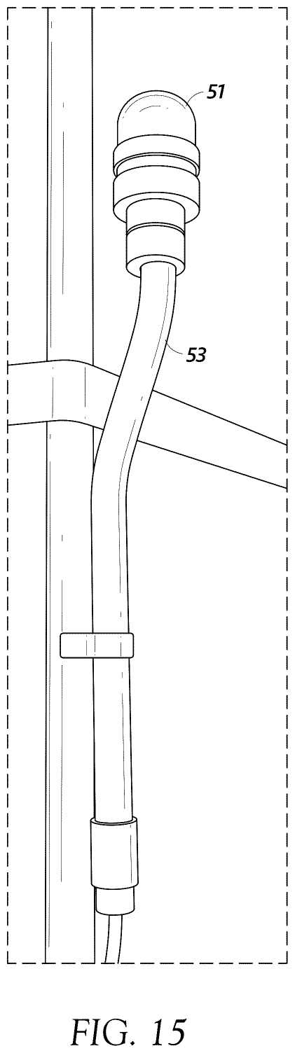

Referring to FIG. 15, a notification light 51, is shown coupled to an alarm light holder 53. The notification light holder 53 can be attached to a part of the smart workstation 1, e.g., positioned at a high location for the best visibility to operators. For example, the notification light holder 53 can be attached to one of the vertical bars of the support frame 30 shown in FIG. 3. As described above with respect to the notification light 50, the notification light 51 can be configured to emit blinking or continuous light and/or in different colors when an out-of-tolerance or out-of-limit event occurs.

In FIG. 16, the software notification 52 described above is shown in the display screen of HMI 20 indicating an out-of-tolerance event. The physical notification lights 50, 51 and the software notification 52 can display the same quality event simultaneously or different events independently of each other depending on configurations and situations.

FIG. 17 shows a security form 83 that controls access to specific configurable variables and/or forms. The security form 83 may set requirements, for example, password protection, that only authorized personnel can access certain forms and define key system and process parameters and reports on the programmable control systems through the HMI 20.

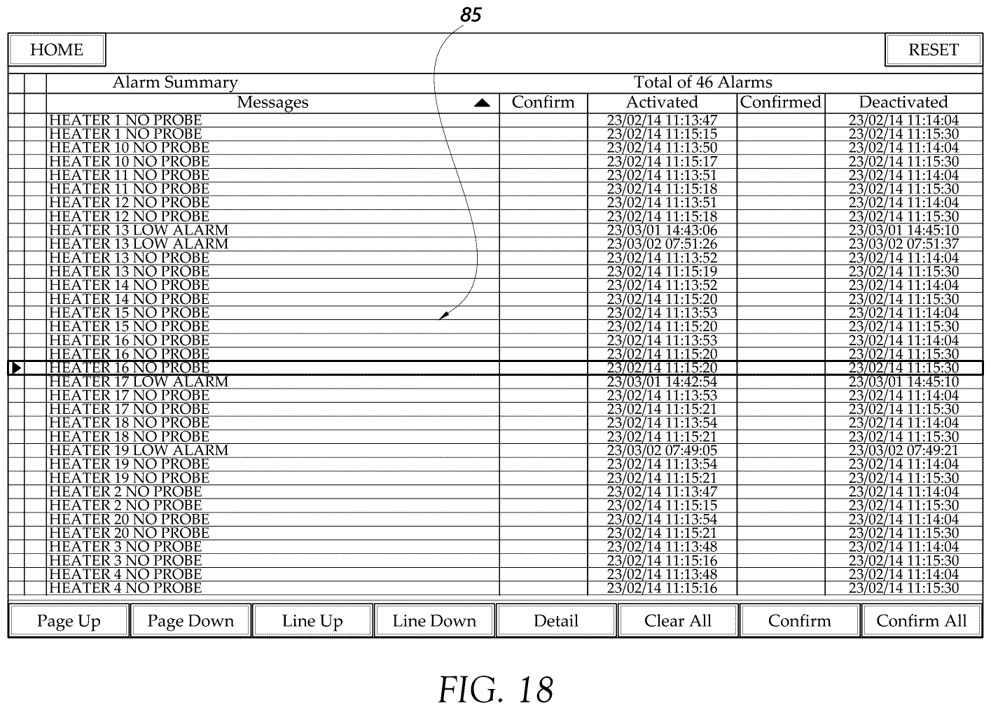

FIG. 18 shows a system report 85 that displays system performance data and out-of-tolerance events. Access to this screen may be controlled by the security form 83 shown above. All data and events are recorded and stored by the programmable control systems residing in the control panel 15. The data can be exported externally such as to a company network, business intelligence system or other computer application(s) where it is then available for further analysis. Typical analyses may focus on operator and equipment efficiency, and diagnostics.

The foregoing description details certain embodiments of the systems, devices, and methods disclosed herein. It will be appreciated, however, that no matter how detailed the foregoing appears in text, the systems, devices, and methods may be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment may be included with other depicted embodiments in any combination. For example, any of the various components described herein and/or depicted in the Figures may be combined, interchanged or excluded from other embodiments.

As used herein, the term coupled to can refer to any suitable connection or other form of interaction between two or more entities, including mechanical. Thus, two components may be coupled to each other even though they are not in direct contact with each other. The phrases “attached to” or “attached directly to” refer to interaction between two or more entities which are in direct contact with each other and/or are separated from each other only by a fastener of any suitable variety (e.g., mounting hardware or an adhesive).

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present disclosure. This disclosure is susceptible to modifications in the methods and materials, as well as alterations in the fabrication methods and equipment. Such modifications will become apparent to those skilled in the art from a consideration of this disclosure or practice of the development disclosed herein. Consequently, it is not intended that this disclosure be limited to the specific embodiments disclosed herein, but that it covers all modifications and alternatives coming within the true scope and spirit of the disclosure as embodied in the attached claims.

While the above detailed description has shown, described, and pointed out novel features of the improvements as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. A smart workstation for working on one or more articles, the workstation comprising:
a work surface;
a plurality of heaters each movably disposed on the work surface and configured to apply heat to a corresponding portion of an article, each heater comprising a heater element and a temperature sensor;
a programmable control system, the programmable control system configured to control each of the plurality heaters and receive temperature data from each of the plurality of heaters; and
wherein the programmable control system is configured to control the heat applied by each of the of the plurality of heaters to maintain a temperature of the corresponding portions of the article within a desired temperature range.

2. The smart workstation of claim 1, further comprising a human machine interface (HMI) in communication with the programmable control system, the HMI configured to receive the desired temperature range for each of the plurality of heaters.

3. The smart workstation of claim 1, further comprising an alert circuit in communication with the programmable control system, and wherein the programmable control system is configured to provide an alert when the temperature of any of the corresponding portions of the article are outside of the desired temperature range.

4. The smart workstation of claim 3, wherein the alert circuit further comprises a visual indicator.

5. The smart workstation of claim 2, wherein the HMI is further configured to receive a time parameter for one or more of the plurality of heaters, and wherein the programmable control system is configured to maintain the temperature of the corresponding portions of the article within the desired temperature range for the received time parameter.

6. The smart workstation of claim 1, further comprising at least one distribution box connected to the programmable control system and to one or more of the plurality of heaters, wherein the distribution box provides electrical power from the programmable control system to the one or more of the plurality of cure heaters and transfers data between the programmable control system and the one or more of the plurality of heaters.

7. The smart workstation of claim 1, further comprising a support frame coupled to the work surface, the support frame extending above the work surface and comprising a plurality of connection supports.

8. The smart workstation of claim 7, wherein each of the plurality of connection supports is configured to support the article.

9. The smart workstation of claim 7, wherein each of the plurality of connection supports is configured to support one of the plurality of heaters, and to maintain the heater in physical contact with the article.

10. The smart workstation of claim 9, wherein each of the plurality of heaters comprises an outer portion, and an inner portion, and wherein the outer portion is sized and shaped to fit a geometry of the surface of the article.

11. The smart workstation of claim 10, wherein the outer portion of the plurality of heaters in contact with the surface of the article comprises a thermally conductive material.

12. The smart workstation of claim 1, wherein the plurality of articles are fuel cells.

13. A method for working on one or more articles, the method comprising:
providing, on a work surface, an article to be worked;
applying a plurality of heaters movably disposed on the work surface to corresponding portions of the article, each of the plurality of heaters comprising a heater element and a temperature sensor;
applying, by each of the plurality of heaters, heat to the corresponding portions of the article;
receiving, in a programmable control system, temperature data from each of the plurality of heaters; and
maintaining a temperature of the corresponding portions of the article in a desired temperature range.

14. The method of claim 13, wherein applying the plurality of heaters to corresponding portions of the article comprises applying a first heater of the plurality of heaters to a first imperfection of the article and applying a second one of the plurality of heaters to a second imperfection of the article.

15. The method of claim 13, wherein a first heater of the plurality of heaters maintains the corresponding portion of the article in a first temperature range, and wherein a second heater of the plurality of heaters maintains the corresponding portion of the article in a second temperature range that is different from the first temperature range.

16. The method of claim 15, wherein the first heater is applied to a first imperfection of the article and wherein the second heater is applied to a second imperfection of the article.

17. The method of claim 13, further comprising, causing, in an alert circuit in communication with the programmable control system, an alert when the temperature of any of the corresponding portions of the article are outside of the desired temperature range.

18. The method of claim 13, further comprising:
receiving, in a human machine interface (HMI) in communication with the programmable control system, a time parameter for one or more of the plurality of heaters; and
maintaining the temperature of the corresponding portions of the article within the desired temperature range for the received time parameter.

19. The method of claim 13, wherein providing, on a work surface, an article to be worked comprises connecting the article to be worked to one or more of a plurality of connection supports coupled to a support frame, the support frame being coupled to the work surface.

20. The method of claim 19 further comprising:
connecting one of the plurality of heaters to one of the plurality connection supports; and
placing the one of the plurality of heaters connected to the one of the plurality of connection supports in contact with the article.
